(19) United States
(12) Patent Application Publication
(10) Pub. No.: US 2014/0132805 A1
(43) Pub. Date: May 15, 2014

(54) IMAGING DEVICE AND IMAGE PROCESSING METHOD

(71) Applicant: Sony Corporation, Tokyo (JP)

(72) Inventors: Takao Inoue, Kanagawa (JP); Sayaka Shida, Tokyo (JP); Hiroyuki Suzuki, Tokyo (JP)

(73) Assignee: Sony Corporation, Tokyo (JP)

(21) Appl. No.: 14/072,177

(22) Filed: Nov. 5, 2013

(30) Foreign Application Priority Data
Nov. 12, 2012 (JP) 2012-248257

(51) Int. Cl. H04N 5/232

(52) U.S. Cl. CPC H04N 5/23229
USPC 348/240.99

(57) ABSTRACT

There is provided an imaging device including an image sensor that performs photoelectric conversion on subject light coming through a lens and generates an image signal, a first development unit that generates first image data having first resolution from the image signal, a second development unit that generates second image data having second resolution that is lower than the first resolution from the image signal or the first image data, and a display processing unit that selects image data of one of the first image data and the second image data as a range to be displayed on a screen for reviewing an image captured by the image sensor according to a size of a region cropped from an image of the first image data or an image of the second image data, and generates an image for display to be displayed using the selected image data.

### CROSS REFERENCE TO RELATED APPLICATIONS

This application claims the benefit of Japanese Priority Patent Application JP 2012-248257 filed Nov. 12, 2012, the entire contents of which are incorporated herein by reference.

### BACKGROUND

The present disclosure relates to an imaging device and an image processing method, and particularly to a technology of enlarging and displaying an image to be displayed on a screen which is used for reviewing a captured image.

In the related art, for the purpose of checking and adjusting a focus position of an image in the course of photographing, the image being displayed on a view finder or a monitor is enlarged and displayed. By enlarging and displaying the image, focus can be adjusted while checking detailed parts of a subject in the image.

However, resolution of an image displayed on a view finder or a monitor is generally lower than resolution of an image formed by image signals obtained in an image sensor. This is because a process of thinning image signals obtained in the image sensor is performed in the horizontal direction and/or the vertical direction in accordance with display resolution of a view finder or a monitor.

For this reason, as the zoom magnification of an image displayed on the view finder or the monitor increases, resolution of the image displayed on the screen is lowered, and it is difficult to check details of the subject. As a technology of displaying a high-definition image on a screen even when a zoom magnification is raised, Japanese Unexamined Patent Application Publication No. 2004-72278 discloses a technique in which zooming using an optical zoom is performed when a zoom magnification is low, and the zooming is switched to an electronic zoom when the zoom magnification is raised.

### SUMMARY

However, when an optical zoom is used as in the technique disclosed in Japanese Unexamined Patent Application Publication No. 2004-72278, it also affects image signals of a main line system stored in a recording device, or the like. In other words, enlargement of an image being displayed on a screen for the purpose of adjusting focus also changes an actual focus position.

It is desirable to improve resolution of an image enlarged and displayed on a screen during focus adjustment, without affecting image signals of a main line system.

In order to solve the above-described problem, an imaging device according to an embodiment of the present disclosure is configured to include an image sensor, a first development unit, a second development unit, and a display processing unit, and configurations and functions of the units are as follows. The image sensor performs photoelectric conversion on subject light coming through a lens and generates an image signal. The first development unit generates first image data having first resolution from the image signal generated by the image sensor. The second development unit generates second image data having second resolution that is lower than the first resolution from the image signal generated by the image sensor or the first image data. The display processing unit selects image data of one of the first image data generated by the first development unit and the second image data generated by the second development unit as a range to be displayed on a screen for reviewing an image captured by the image sensor according to a size of a region cropped from an image of the first image data or an image of the second image data, and generates an image for display to be displayed on the screen for reviewing the captured image using the selected image data.

In addition, in an image processing method according to an embodiment of the present disclosure, processes are performed in the following order. First, an image signal is generated by performing photoelectric conversion on subject light coming through a lens. Next, first image data having first resolution is generated from the image signal. Second image data having second resolution that is lower than the first resolution is generated from the image signal or the first image data. Next, image data of one of the first image data and the second image data is selected as a range to be displayed on a screen for reviewing a captured image according to a size of a region cropped from an image of the first image data or an image of the second image data. Then, an image for display to be displayed on the screen for reviewing the captured image is generated using the selected image data.

By configuring the imaging device and performing the image processes as described above, the image for display to be displayed on the screen for reviewing a captured image is generated without using an optical zoom. In addition, since the first image data having high resolution is used in the generation of the image for display, even when the image to be displayed on the screen for reviewing a captured image is enlarged, the image quality does not deteriorate.

According to the imaging device and the image processing method of an embodiment of the present disclosure, it is possible to improve resolution of an image enlarged and displayed on a screen during focus adjustment, without affecting image signals of a main line system.

### BRIEF DESCRIPTION OF THE DRAWINGS

FIG. 1 is a block diagram illustrating a configuration example of an imaging device according to an embodiment of the present disclosure;

FIG. 2 is an illustrative diagram for describing an example of a process by a zoom display processing unit according to the embodiment of the present disclosure;

FIG. 3 is a block diagram illustrating a configuration example of the zoom display processing unit according to the embodiment of the present disclosure;

FIG. 4 is a graph illustrating an example of a process performed by the zoom display processing unit according to the embodiment of the present disclosure;

FIGS. 5A to 5C are illustrative diagrams showing examples of processes performed by a cropping process part and a resolution adjustment part according to the embodiment of the present disclosure, FIG. 5A showing a process performed when zoom magnification is 1, FIG. 5B showing a process performed when zoom magnification is 1.5, and FIG. 5C showing a process performed when zoom magnification is 2;

FIGS. 6A to 6C are illustrative diagrams showing examples of processes by performed the cropping process part and the resolution adjustment part according to the embodiment of the present disclosure, FIG. 6A showing a process performed when zoom magnification is 2, FIG. 6B showing a process performed when zoom magnification is 4, and FIG. 6C showing a process performed when zoom magnification is 8; and

FIG. 7 is a flowchart showing an example of a switching process performed by a selector in each image process according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An example of an imaging device according to an embodiment of the present disclosure will be described in the following order with reference to the drawings.

1. Configuration example of an imaging device

2. Configuration example of a zoom display processing unit

3. Process example of the zoom display processing unit

4. Various modified examples

### <1. Configuration Example of an Imaging Device>

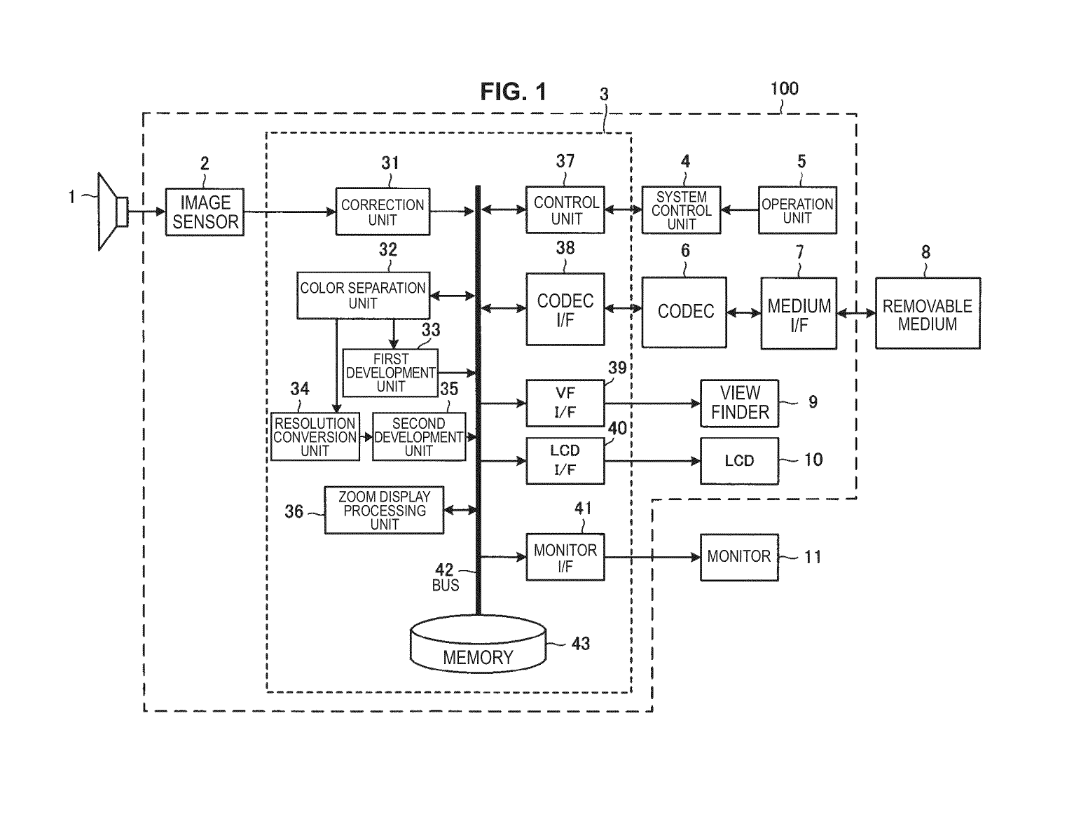

FIG. 1 is a block diagram illustrating a configuration of an imaging device 100 according to an embodiment of the present disclosure. The imaging device 100 has a lens 1 including a focus lens, a zoom lens, and the like, an image sensor 2, and a signal processing circuit 3. The lens 1 includes a shutter, an iris, and the like which are not illustrated, and causes an image of subject light to be formed in an imaging region (omitted in the drawing) of the image sensor 2. In addition, the lens 1 includes a lens drive unit (omitted in the drawing) which moves positions of the various lenses in an optical axis direction. The lens 1 can be appropriately replaced according to an environment in which the imaging device 100 is used.

The image sensor 2 performs photoelectric conversion on subject light which has passed through the lens 1 and of which an image is formed in the imaging region, and thereby generates image signals. In the imaging region of the image sensor 2, pixels which are not illustrated are arranged in a matrix shape, and in front of each of the pixels, color filters arrayed in, for example, a Bayer form are arranged.

In other words, image signals of R (red), G (green), and B (blue) are output from the image sensor 2. The image sensor 2 is configured by, for example, a CCD (Charge Coupled Device) image sensor, or a CMOS (Complementary Metal Oxide Semiconductor) image sensor. In addition, resolution of the image sensor is set to be, for example, 4K (4096×2160 pixels; first resolution). Note that “resolution” described in the present specification refers to resolution decided based on the number of pixels of an image. Therefore, resolution of an image is proportional to the number of pixels thereof (image size).

The signal processing circuit 3 performs a predetermined signal process on the image signals obtained in the image sensor 2. Details of the signal processing circuit 3 will be described later. In addition, the imaging device 100 has a system control unit 4 and an operation unit 5. The system control unit 4 includes a CPU (Central Processing Unit), and the like, and controls each unit constituting the imaging device 100. The operation unit 5 has U/Is (User Interfaces) such as a button, a lever, a switch, and the like, and generates operation signals according to operation details instructed to the U/Is from a user and supplies the signals to the system control unit 4. The operation unit 5 also includes a focus ring which is used to adjust focus, and when a user performs an operation of rotating the focus ring, the operation unit computes a zoom magnification according to the amount of rotation and supplies the value to the system control unit 4.

In addition, the imaging device 100 has a codec 6, a medium I/F 7, and a removable medium 8. The codec 6 encodes or decodes image data. The medium I/F 7 is an interface into which the removable medium 8 is inserted, and performs writing processes or reading processes of image data on or from the removable medium 8. The removable medium 8 includes, for example, a memory card, and stores image data encoded by the codec 6.

In addition, the imaging device 100 has a view finder 9 and an LCD 10. The view finder 9 is configured by, for example, a liquid crystal display, and displays images captured by the image sensor 2. Display resolution (the number of display pixels) of the view finder 9 is set to be, for example, 1K (1024×540 pixels). The LCD 10 is configured by, for example, a liquid crystal display, and displays setting items with regard to photographing, and images captured by the image sensor 2 thereon.

Next, with reference to FIG. 1 again, details of the signal processing circuit 3 will be described. The signal processing circuit 3 includes a correction unit 31, a color separation unit 32, a first development unit 33, a resolution conversion unit 34, a second development unit 35, and a zoom display processing unit 36 as a display processing unit.

The correction unit 31 performs various correction processes such as defect correction, shading correction, a white balance process, and the like on the image signals obtained by the image sensor 2. The color separation unit 32 performs a color separation process on the image signals which has been corrected by the correction unit 31 to generate RGB signals. The first development unit 33 performs gamma correction, contour correction, white balance adjustment, or the like on the RGB signals generated by the color separation unit 32 and converts the RGB signals on which such adjustment has been performed into YC signals to generate image data (first image data). Resolution of the first image data is 4K, which is the same as the resolution of the image signals obtained by the image sensor 2.

The resolution conversion unit 34 converts resolution of the RGB signals generated by the color separation unit 32. For example, the resolution conversion unit converts the resolution from 4K into 2K (2048×1080 pixels; second resolution).

The process of converting the resolution from 4K into 2K is performed, for example, for the purpose of saving the band of a bus 42 which is a path of data exchanged between each part of the signal processing circuit 3. The second development unit 35 generates image data by converting the RGB signals of which the resolution has been converted into 2K by the resolution conversion unit 34 into YC signals.

The zoom display processing unit 36 generates an image for display to be displayed on the view finder 9 to be described later using 4K image data P1 developed by the first development unit 33 and 2K image data P2 generated by the second development unit 35.

In addition, the signal processing circuit 3 includes a control unit 37, a codec I/F 38, a view finder (marked by VF in the drawing) I/F 39, an LCD I/F 40, a monitor I/F 41, and a memory 43. The control unit 37 controls each block constituting the signal processing circuit 3 based on control of the system control unit 4. The codec I/F 38 is an interface between the codec 6 and the signal processing circuit 3, the view finder I/F 39 is an interface between the view finder 9 and the signal processing circuit 3, and the LCD I/F 40 is an interface between the LCD 10 and the signal processing circuit 3. The monitor I/F 41 is an interface between the monitor 11 and the signal processing circuit 3, to which the monitor 11 that can display, for example, 4K or 2K images is connected.

The memory 43 is a frame buffer including, for example, an SDRAM (Synchronous Dynamic Random Access Memory), and the like. The memory 43 temporarily stores images which have been processed by each unit of the signal processing circuit 3. Units constituting the signal processing circuit 3 described above are connected to one another via the bus 42.

### <2. Configuration Example of a Zoom Display Processing Unit>

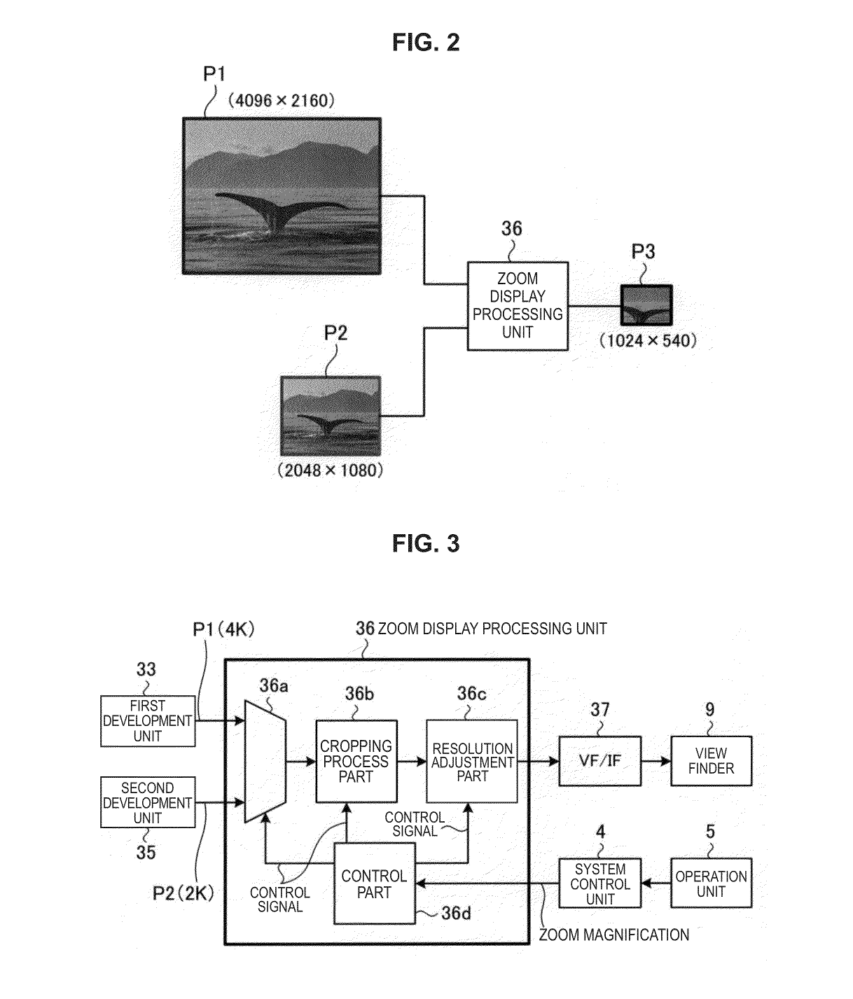

Next, a configuration example of the zoom display processing unit 36 will be described with reference to FIGS. 2 and 3. The zoom display processing unit 36 is a unit which performs a process of generating an image for display P3 to be displayed on the view finder 9 (see FIG. 1) by enlarging or reducing the image size of the 4K image data P1 or the 2K image data P2 as illustrated in FIG. 2. Resolution of the image for display P3 is 1K which is display resolution of the view finder 9.

FIG. 3 is a block diagram illustrating a configuration example of the zoom display processing unit 36. The zoom display processing unit 36 includes a selection part 36a, a cropping process part 36b, a resolution adjustment part 36c, and a control part 36d.

The selection part 36a is a selector which selects and outputs one side of the 4K image data P1 output from the first development unit 33 and the 2K image data P2 output from the second development unit 35. The cropping process part 36b performs a process of extracting and cropping (trimming) a region to be enlarged and displayed from an image of the image data selected by the selection part 36a. The resolution adjustment part 36c performs a process of raising or lowering resolution of the image cropped by the cropping process part 36b in accordance with display resolution of the screen of the view finder 9. In other words, the resolution adjustment part performs a process of reducing or enlarging the size of the image cropped by the cropping process part 36b in accordance with the size of the screen of the view finder 9. Consequently, zooming using the technique of an electronic zoom is performed with the cropping process part 36b and the resolution adjustment part 36c.

The control part 36d generates control signals based on a zoom magnification input by a user via the operation unit 5 (see FIG. 1), and supplies the generated control signals to the selection part 36a, the cropping process part 36b, and the resolution adjustment part 36c. To be specific, a control signal which instructs image data to be selected is generated and supplied to the selection part 36a, and a control signal which designates a cropping range is generated and supplied to the cropping process part 36b. In addition, a control signal which designates an enlargement rate or a reduction rate of resolution is generated and supplied to the resolution adjustment part 36c. Note that, without providing the control part 36d, the control unit 37 (see FIG. 1) may be caused to perform the process performed by the control part 36d.

### <3. Process Example of the Zoom Display Processing Unit>

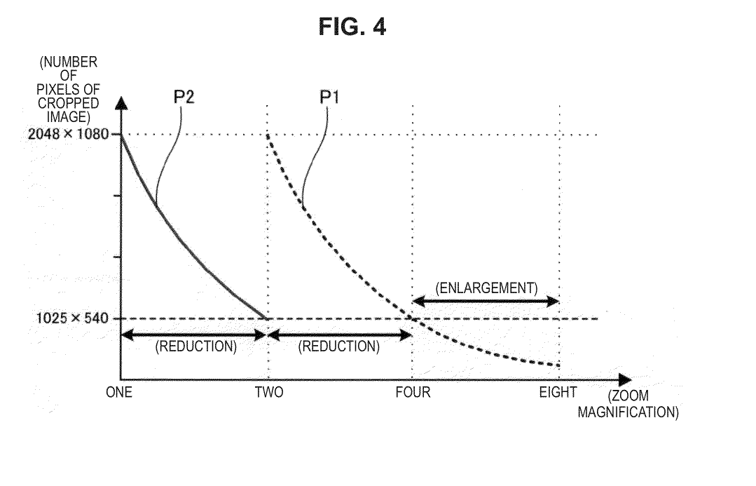

Next, a process example of the zoom display processing unit 36 will be described with reference to FIGS. 4 to 7. FIG. 4 is a graph showing correspondence of the process performed by the zoom display processing unit 36 and a zoom magnification input by a user. The vertical axis of FIG. 4 represents the number of pixels of a cropped image which is cropped by the cropping process part 36b, and the horizontal axis thereof represents zoom magnifications. In addition, in FIG. 4, the number of pixels of the 2K image data P2 is indicated by a solid line, and the number of pixels of the 4K image data P1 is indicated by a dotted line.

Within the zoom magnification section from 1 to 2 that is a first magnification, a process in which the 2K image data P2 is selected by the selection part 36a, and a predetermined region is cropped from an image of the image data P2 by the cropping process part 36b is performed. In addition, the resolution adjustment part 36c performs a process in which the size of the cropped image is reduced, and the image for display P3 to be displayed on the view finder 9 is generated. The reduction of the size of the cropped image is performed by, for example, thinning the number of pixels of the cropped image.

At the time when the zoom magnification becomes 2, the image data selected by the selection part 36a is switched from the 2K image data P2 to the 4K image data P1. Then, the cropping process part 36b performs a process of cropping a predetermined region from an image of the image data P1. Within the zoom magnification section from 2 to 4, the resolution adjustment part 36c performs a process in which the size of the cropped image is reduced, and the image for display P3 is generated. In sections of 4 and thereafter, a process of enlarging the size of the cropped mage and generating the image for display P3 is performed. The enlargement of the size of the cropped image is performed using, for example, a process of interpolating deficient pixels.

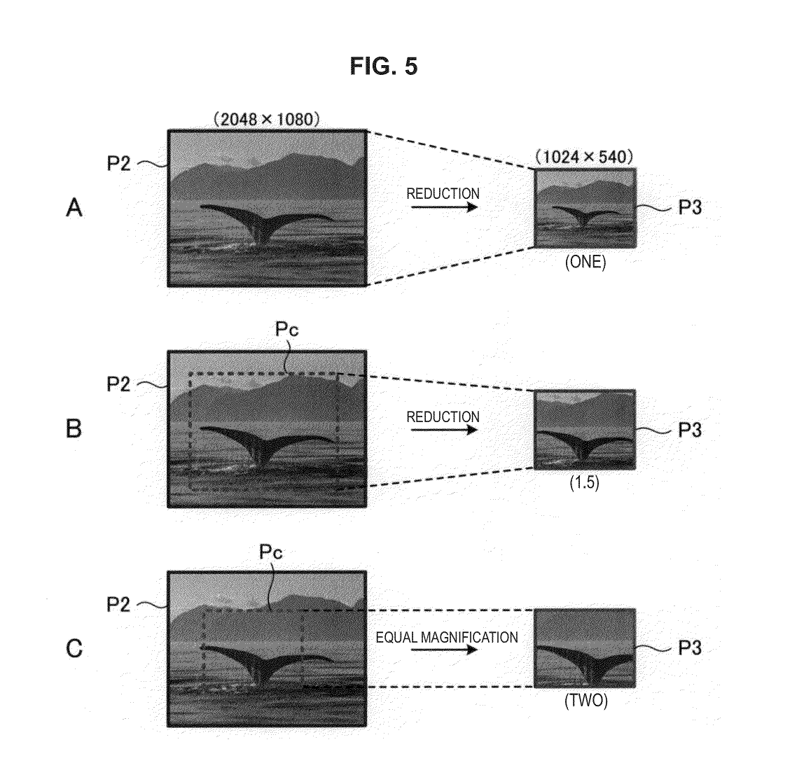

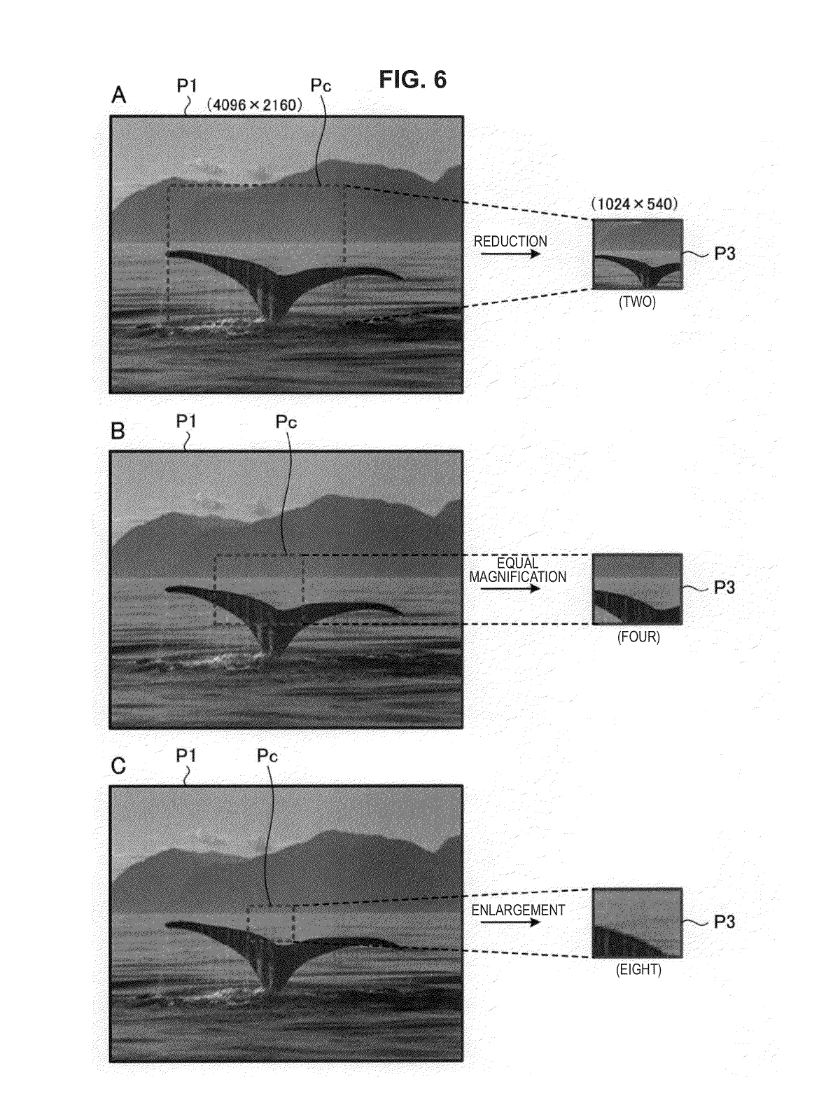

FIGS. 5A to 5C and FIGS. 6A to 6C are illustrative diagrams showing examples of processes performed by the cropping process part 36b and the resolution adjustment part 36c. In FIGS. 5A to 5C and FIGS. 6A to 6C, the images on the left are images output from the selection part 36a, and the images on the right are images for display P3 which are displayed on the view finder 9. The ranges indicated by the dotted-lined frames in the images on the left indicate ranges cropped by the cropping process part 36b. The values below the images on the right indicate zoom magnifications designated by a user.

When the zoom magnification is 1, the resolution adjustment part 36c reduces the size of the image of the 2K image data P2 to 1K, and thereby generates the image for display P3 as illustrated in FIG. 5A. The reduction of the size of the image is performed by, for example, thinning pixels included in the image data in the horizontal direction and/or in the vertical direction.

When the zoom magnification is 1.5, a region to be enlarged and displayed is cropped by the cropping process part 36b, and thereby a cropped image Pc is generated as illustrated in FIG. 5B. When the zoom magnification is 1.5, the size of the cropped image Pc generated from the 2K image data P2 is smaller than 1K which is display resolution of the view finder 9. For this reason, in the resolution adjustment part 36c, the image for display P3 to be displayed on the view finder 9 is generated by reducing the size of the cropped image Pc.

When the zoom magnification is 2, a region to be enlarged and displayed is cropped by the cropping process part 36b, and thereby the cropped image Pc is generated as illustrated in FIG. 5C. When the zoom magnification is 2, the size of the cropped image Pc generated from the 2K image data P2 is equal to 1K which is display resolution of the view finder 9. For this reason, in the resolution adjustment part 36c, the image for display P3 is generated with the same size without changing the size of the cropped image Pc.

In addition, the image data selected by the selection part 36a is switched from the 2K image data P2 to the 4K image data P1 when the zoom magnification exceeds 2. In the section of the zoom magnification from 2 times to 4, a region to be enlarged and displayed is cropped by the cropping process part 36b, and thereby the cropped image Pc is generated as illustrated in FIG. 6A. The size of the cropped image Pc illustrated in FIG. 6A becomes equal to the size of the cropped image Pc illustrated in FIG. 5C.

The size of the cropped image Pc generated from the 4K image data P1 as illustrated in FIG. 6A is greater than 1K which is display resolution of the view finder 9 in the section of the zoom magnification from 2 to 4. For this reason, in the resolution adjustment part 36c, the image for display P3 to be displayed on the view finder 9 is generated by reducing the size of the cropped image Pc.

When the zoom magnification becomes 4, a region to be enlarged and displayed is cropped by the cropping process part 36b, and thereby the cropped image Pc is generated as illustrated in FIG. 6B. The size of the cropped image Pc generated from the 4K image data P1 when the zoom magnification is 4 is equal to 1K which is display resolution of the view finder 9. For this reason, in the resolution adjustment part 36c, the image for display P3 is generated with the same size without changing the size of the cropped image Pc.

In the section of the zoom magnification from 4 to 8, a region to be enlarged and displayed is also cropped by the cropping process part 36b, and thereby the cropped image Pc is generated as illustrated in FIG. 6C. When the zoom magnification is 4 or higher, the size of the cropped image Pc generated from the 4K image data P1 becomes smaller than 1K which is display resolution of the view finder 9. For this reason, in the resolution adjustment part 36c, the image for display P3 to be displayed on the view finder 9 is generated by increasing the size of the cropped image Pc.

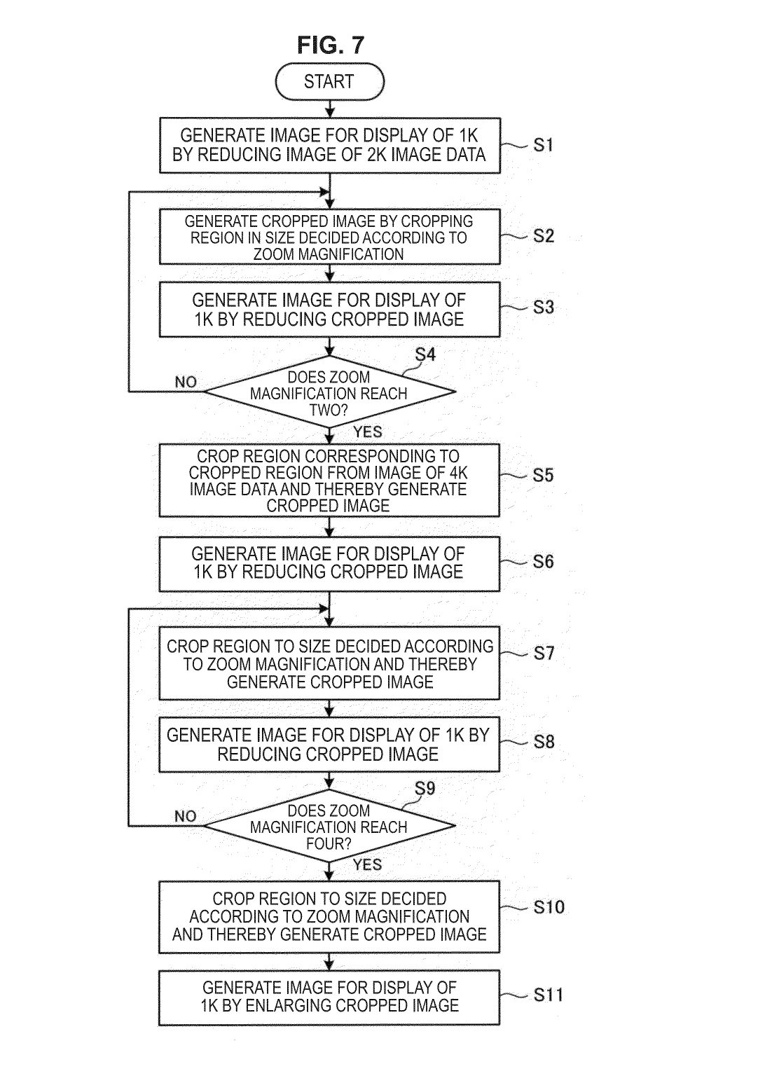

FIG. 7 is a flowchart of the process performed by the zoom display processing unit 36 described with reference to FIGS. 5A to 5C and FIGS. 6A to 6C. FIG. 7 shows a process of the zoom display processing unit 36 when the zoom magnification gradually increases from 1 to 8.

In the state of the zoom magnification of 1, the image for display P3 in the size of 1K is generated by reducing the size of an image of the 2K image data P2 (Step S1). Then, along with an increase of the zoom magnification, a region in the size decided according to the set zoom magnification is cropped by the cropping process part 36b, and thereby the cropped image Pc is generated (Step S2). Then, the cropped image Pc is reduced by the resolution adjustment part 36c, and thereby the image for display P3 is generated (Step S3).

Next, the control part 36d determines whether or not the zoom magnification designated by a user reaches 2 (Step S4). When the zoom magnification does not exceed 2, the process returns to Step S2 and then proceeds. When the zoom magnification exceeds 2, a region corresponding to the region cropped from the 2K image data P2 as the cropped image Pc is cropped from the 4K image data P1, and thereby the cropped image Pc is generated (Step S5). Then, the image for display P3 in the size of 1K is generated by the resolution adjustment part 36c by reducing the cropped image Pc (Step S6).

In addition, along with an increase of the zoom magnification, a region in the size decided according to a set zoom magnification is cropped by the cropping process part 36b, and thereby the cropped image Pc is generated (Step S7). Then, the image for display P3 is generated by the resolution adjustment part 36c by reducing the size of the cropped image Pc (Step S8).

Next, the control part 36d determines whether or not the zoom magnification reaches 4 (Step S9). When the zoom magnification does not exceed 4, the process returns to Step S7 and then proceeds. When the zoom magnification exceeds 4, a region in the size decided according to a set zoom magnification is cropped by the cropping process part 36b, and thereby the cropped image Pc is generated (Step S10). Then, the image for display P3 is generated by the resolution adjustment part 36c by enlarging the cropped image Pc (Step S11).

According to the embodiment described above, when the zoom magnification exceeds 2, the image data used in the generation of the image for display P3 is switched from the 2K image data P2 to the 4K image data P1. Thereby, zoom is performed using an image with resolution of 4K in the zoom magnification of 2 or higher, and thus, even if an image is enlarged by zooming, details of a subject can be expressed in high definition.

In addition, according to the embodiment described above, switching of image data used in the generation of the image for display P3 is automatically performed according to the zoom magnification. Thus, a user does not have to be conscious of performing a process of switching or the like, and an image displayed on the screen of the view finder 9 is switched to a high-definition image of the image data P1.

In addition, when image data to be used in the generation of the image for display P3 is switched to the 4K image data P1, a region in the same range as that cropped from an image of the 2K image data P2 is cropped from an image of the 4K image data P1. In other words, while only resolution of an image displayed on the screen of the view finder 9 is changed, the size thereof is not changed. For this reason, even when the 2K image data P2 is switched to the 4K image data P1, smooth zoom display is continuously performed without interruption.

### <4. Various Modified Examples>

Note that, although the embodiment described above exemplifies that the image for display P3 is generated using the 4K image data P1 and the 2K image data P2, it is not limited thereto. Any combination of resolution of image data may be used in the generation as long as the image data is image data with high resolution and image data converted to low resolution by the resolution conversion unit 34.

In addition, although the embodiment described above exemplifies that image data for generating the image for display P3 is switched from the 2K image data P2 to 4K image data P1 when the zoom magnification is 2, it is not limited thereto. The zoom magnification may be set to another value such as 3, or the like.

In addition, in the embodiment described above, a zoom magnification with which the size of a region cropped by the cropping process part 36b is equal to the display resolution (1K in the embodiment described above) of the screen of the view finder 9 is set as a zoom magnification when the selection part 36a switches image data. However, a timing at which the size of the cropped image Pc is not equal to the display resolution of the screen of the view finder 9 may be set as a switching timing of image data.

In addition, although the embodiment described above exemplifies that the zoom magnification is from 1 to 8, the zoom magnification is not limited thereto.

In addition, although the embodiment described above exemplifies that a display unit which performs enlargement or reduction of a screen is set to be the view finder 9, it is not limited thereto. Another display unit or a display device such as the LCD 10, or the monitor 11 (see FIG. 1) may be the display unit as long as it displays an image thereon during focus adjustment.

In addition, although the cropping process part 36b is provided after the selection part 36a in the zoom display processing unit 36 in the embodiment described above, the cropping process part 36b may be provided before the selection part 36a. In such a case, two cropping process parts 36b for the first development unit 33 and the second development unit 35 may be provided.

Additionally, the present technology may also be configured as below.

(1) An imaging device including:

an image sensor that performs photoelectric conversion on subject light coming through a lens and generates an image signal;

a first development unit that generates first image data having first resolution from the image signal generated by the image sensor;

a second development unit that generates second image data having second resolution that is lower than the first resolution from the image signal generated by the image sensor or the first image data; and

a display processing unit that selects image data of one of the first image data generated by the first development unit and the second image data generated by the second development unit as a range to be displayed on a screen for reviewing an image captured by the image sensor according to a size of a region cropped from an image of the first image data or an image of the second image data, and generates an image for display to be displayed on the screen for reviewing the captured image using the selected image data.

(2) The imaging device according to (1), wherein the display processing unit generates the image for display by performing a process of thinning or a process of interpolating pixels of the first image data or the second image data.
(3) The imaging device according to (1) or (2), wherein the display processing unit generates the image for display using the second image data in a period in which a zoom magnification input by a user through an operation unit reaches a first magnification which is a predetermined magnification, and generates the image for display using the first image data when the zoom magnification exceeds the first magnification.
(4) The imaging device according to any one of (1) to (3), wherein the display processing unit includes a selection part that selects one of the first image data and the second image data, a cropping process part that crops an image of a region to be displayed on the screen for reviewing the captured image from an image of the image data selected by the selection part, and a resolution adjustment part that adjusts resolution of the image cropped by the cropping process part in accordance with display resolution of the screen for reviewing the captured image.
(5) The imaging device according to (4), further including:

a control part that generates a control signal based on a zoom magnification input by a user through the operation unit and supplies the generated control signal to the selection part, the cropping process part, and the resolution adjustment part of the display processing unit.

(6) The imaging device according to (4) or (5), wherein the first magnification is a magnification with which resolution of the image cropped by the cropping process part of the display processing unit is equal to the display resolution of the screen for reviewing the captured image.
(7) An image processing method including:

generating an image signal by performing photoelectric conversion on subject light coming through a lens;

generating first image data having first resolution from the generated image signal;

generating second image data having second resolution that is lower than the first resolution from the image signal or the first image data; and

selecting image data of one of the first image data and the second image data as a range to be displayed on a screen for reviewing a captured image according to a size of a region cropped from an image of the first image data or an image of the second image data, and generating an image for display using the selected image data.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device comprising:
an image sensor that performs photoelectric conversion on subject light coming through a lens and generates an image signal;
a first development unit that generates first image data having first resolution from the image signal generated by the image sensor;
a second development unit that generates second image data having second resolution that is lower than the first resolution from the image signal generated by the image sensor or the first image data; and
a display processing unit that selects image data of one of the first image data generated by the first development unit and the second image data generated by the second development unit as a range to be displayed on a screen for reviewing an image captured by the image sensor according to a size of a region cropped from an image of the first image data or an image of the second image data, and generates an image for display to be displayed on the screen for reviewing the captured image using the selected image data.

2. The imaging device according to claim 1, wherein the display processing unit generates the image for display by performing a process of thinning or a process of interpolating pixels of the first image data or the second image data.

3. The imaging device according to claim 2, wherein the display processing unit generates the image for display using the second image data in a period in which a zoom magnification input by a user through an operation unit reaches a first magnification which is a predetermined magnification, and generates the image for display using the first image data when the zoom magnification exceeds the first magnification.

4. The imaging device according to claim 3, wherein the display processing unit includes a selection part that selects one of the first image data and the second image data, a cropping process part that crops an image of a region to be displayed on the screen for reviewing the captured image from an image of the image data selected by the selection part, and a resolution adjustment part that adjusts resolution of the image cropped by the cropping process part in accordance with display resolution of the screen for reviewing the captured image.

5. The imaging device according to claim 4, further comprising:
a control part that generates a control signal based on a zoom magnification input by a user through the operation unit and supplies the generated control signal to the selection part, the cropping process part, and the resolution adjustment part of the display processing unit.

6. The imaging device according to claim 5, wherein the first magnification is a magnification with which resolution of the image cropped by the cropping process part of the display processing unit is equal to the display resolution of the screen for reviewing the captured image.

7. An image processing method comprising:
generating an image signal by performing photoelectric conversion on subject light coming through a lens;
generating first image data having first resolution from the generated image signal;
generating second image data having second resolution that is lower than the first resolution from the image signal or the first image data; and
selecting image data of one of the first image data and the second image data as a range to be displayed on a screen for reviewing a captured image according to a size of a region cropped from an image of the first image data or an image of the second image data, and generating an image for display to be displayed on the screen for reviewing the captured image using the selected image data.
